(19) United States
(12) Patent Application Publication
(10) Pub. No.: US 2007/0071018 A1
(43) Pub. Date: Mar. 29, 2007

(54) Method of filtering a plurality of data packets

(76) Inventors: Jose A. Laboy, Tempe, AZ (US); Brian A. Hansche, Gilbert, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/240,172

(22) Filed: Sep. 29, 2005

(51) Int. Cl. H04L 12/56; H04L 12/54

(52) U.S. Cl. 370/401; 370/428

(57) ABSTRACT

A method of filtering a plurality of data packets may include a radio access network (RAN) receiving the plurality of data packets and determining if a mobile station coupled to the RAN is in a dormant state and a reactivation request is not pending for the mobile station. If the mobile station is in a dormant state and a reactivation request is not pending then a data packet filtering module located at a packet gateway function of the RAN identifies a reactivation request data packet from the plurality of data packets, where the reactivation request data packet is coupled to reactivate the mobile station. The data packet filtering module evaluates the reactivation request data packet against a rule set, where the rule set is unique to the mobile station. The reactivation request data packet is forwarded if data packet filtering module indicates a forward condition; and discarded if the data packet filtering module indicates a discard condition.

### BACKGROUND OF INVENTION

With the advent of Internet data services over wireless networks, cellular radio access networks have become susceptible to the same denial of service and hacker attacks as convention wired data networks. However, unlike a wired network, where the terminal devices are always connected, a wireless device must be paged and a channel allocated and configured before data packets can be delivered to the wireless device.

The overhead associated allocated and configuring a traffic channel makes radio access networks particularly susceptible to congestion and overload whenever Internet data is sent to a large number of dormant mobile stations over a short period of time. For example, such an event may be caused unintentionally by a rouge user scanning the IP address space for open TCP or UDP ports, or intentionally by a rouge user as a denial of service attack, or unintentionally by an ill-behaved application from a legitimate user.

There is a need, not met in the prior art, for a method of selectively filter data packets destined to reactivate a mobile station in a dormant state. Accordingly, there is a significant need for an apparatus and method that overcomes the deficiencies of the prior art outlined above.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a block diagram of a wireless communication system in accordance with an exemplary embodiment of the present invention;

FIG. 2 representatively illustrates a more detailed block diagram of a wireless communication system in accordance with an exemplary embodiment of the present invention; and

FIG. 3 representatively illustrates flow diagram in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

A detailed description of an exemplary application, namely a method of filtering a plurality of data packets, is provided as a specific enabling disclosure that may be generalized to any application of the disclosed system, device and method in accordance with various embodiments of the present invention.

Wireless communication systems are well known and consist of many types including land mobile radio, cellular radiotelephone (inclusive of analog cellular, digital cellular, personal communication systems (PCS) and wideband digital cellular systems), and other communication system types. In cellular radiotelephone communication systems, for example, a number of communication cells are typically comprised of one or more Base Transceiver Stations (BTS's) coupled to one or more Base Station Controllers (BSCs) or Central Base Station Controllers (CBSCs) and forming a Radio Access Network (RAN). The BSCs or CBSCs are may be coupled to a Mobile Switching Center (MSC) that provides a connection between the RAN and an external network, such as a Public Switched Telephone Network (PSTN), or they may be coupled to external elements that provide authentication or other management functions such as databases containing information about individual users subscriptions. In addition, the BSCs or CBSCs may be directly interconnected to other RANs. Each BTS provides communication services to a mobile station (MS) located in a coverage area serviced by the BTS via a communication resource that includes a forward link for transmitting signals to, and a reverse link for receiving signals from, the MS.

In cellular network systems, for example in a CDMA cellular network, a mobile station may be in a dormant state, where the cellular network is aware of the mobile station on the system, but currently, there is no activity with the mobile station. In other words, the mobile station is registered with the cellular network, but in a dormant data session as no active communication sessions are taking place. An example of this is a mobile station that is registered and has been active in the cellular network, but is currently inactive without having powered off, such as a mobile station in a push-to-talk session, a mobile station awaiting a paging or reactivation request, and the like.

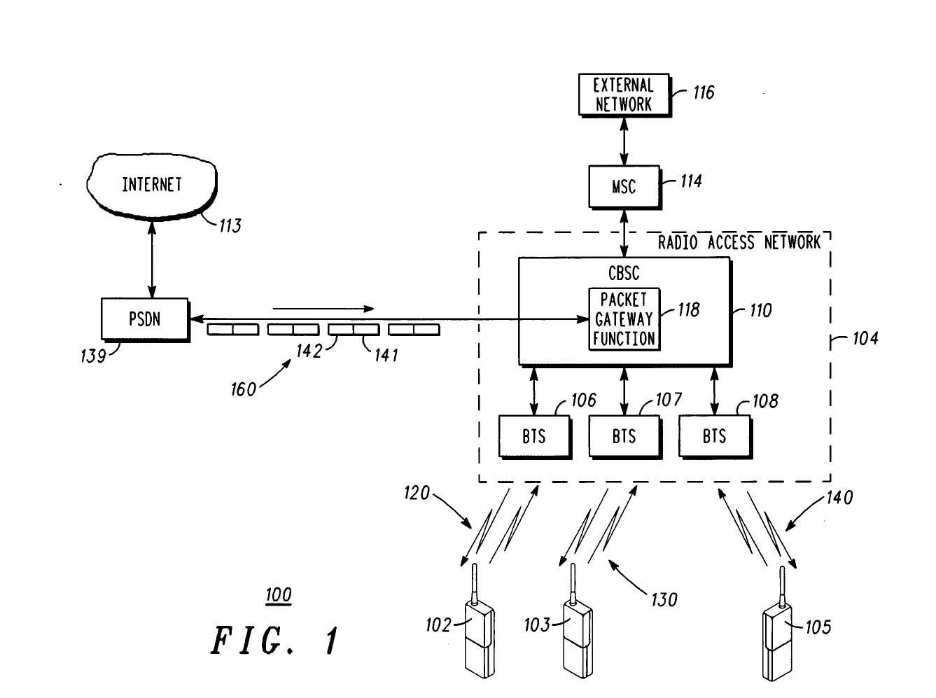

FIG. 1 representatively illustrates a block diagram of a wireless communication system 100 in accordance with an exemplary embodiment of the present invention. Wireless communication system 100 includes a RAN 104 comprising multiple BTSs 106-108 that are each coupled to a CBSC 110. RAN 104 is coupled to an MSC 114, and MSC 114 is in turn coupled to an external network 116 and provides a communication link between the external network, or other RANs, and RAN 104. In an embodiment, RAN 104 is a CDMA network.

Wireless communication system 100 further includes a mobile station 102, 103, 105 that may be in a dormant data session with a BTS 106, 107, 108. That is, mobile station 102 if it is in a dormant data session, for example, is not in an active communication session with BTS 106, but is powered-up, registered and may have been recently in an active communication session with BTS 106. While RAN 104 is aware of mobile station 102, no active communication is currently occurring between mobile station 102 and RAN 104. In a dormant data session, mobile station 102 is a dormant mobile station, which is registered with RAN 104 and coupled to send or receive data via wireless link 120. Each communication link 120, 130, 140 includes a respective forward link for conveyance of signals to mobile station 102 and a respective reverse link for receipt of signals from the mobile station 102. Either mobile station 102 receiving a data packet via RAN 104, or a user of mobile station 102 sending a data packet may reactivate dormant data session. Any number of mobile stations 102, 103, 105 may be coupled to RAN 104 and be in a dormant data session.

CBSC 110 may also include packet gateway function 118. In an embodiment, packet gateway function 118 is coupled to communicate packet data, particularly IP packet data, between the mobile station 102, and the Packet Data Serving Node (PDSN) 139. Packet gateway function 118 may operate to maintain a reachable state between RAN 104 and mobile station 102, ensuring a consistent link for data packets, buffering of data packets arriving from PDSN 139 when wireless link resources are not in place or are insufficient to support the flow from PDSN 139, and relay data packets between the mobile station 102 and PDSN 139. An exemplary embodiment of packet gateway function 118 is a Packet Control Function (PCF) in a CDMA network. However, packet gateway function 118 is not limited to a PCF in a CDMA network and may include one or more nodes in other radio access networks such as GSM, TDMA, and the like, that perform a substantially similar function.

PDSN 139 may be coupled to operate as the gateway from the RAN 104 into a public and/or private packet network, for example and without limitation, the Internet 113. In an embodiment, PDSN 139 may act as a network access server, home agent, foreign agent, and the like. PDSN 139 may manage the radio-packet interface between RAN 104 and Internet 113, provide IP addresses for the subscriber's mobile station 102, 103, 105, perform packet routing, actively manage subscriber services based on profile information, authenticate users, and the like.

In an embodiment, packet gateway function 118 may be coupled to receive incoming data packets addressed to a mobile station 102 in a dormant state. In other words, packet gateway function 118 may be coupled to receive incoming data packets addressed to reactivate a dormant data session with mobile station 102. Such incoming data packets may originate from a packet data network external to RAN 104, such as users connected to the Internet 113, and the like. As an example, incoming data packets may be incoming data coupled with a push-to-talk session, paging request, and the like. For example, mobile station 102 may be registered with RAN 104 but have no currently active data sessions in progress, i.e. mobile station 102 is in a dormant data session. The arrival of a data packet, for example as part of a paging request, may operate to reactivate dormant data session by reactivating dormant mobile station 102.

In an embodiment, packet gateway function 118 is coupled to examine incoming data packets and determine if reactivation of a dormant data session with a dormant mobile station is permitted. In an exemplary embodiment, packet gateway function 118 may operate to examine an incoming data packet targeted to reactivate a mobile station in a dormant state and determine if the packet is allowed to reactive the mobile station based on a rule set defined by the subscriber of the mobile station.

In an illustrative embodiment, a plurality of packets 160 may be received by packet gateway function 118 via PDSN 139. In an embodiment, plurality of packets 160 may include any number of data packets, for example and without limitation IP packets. Each of plurality of packets 160 may have a source IP address 142 and a destination IP address 141. The source IP address 142 is an indication of the origination of the data packet, while the destination IP address 141 may be coupled to reactivate one or more mobile stations 102, 103, 105 that are in a dormant state. In other words, one or more of plurality of packets 160 may be addressed to reactivate a dormant data session with one or more of mobile stations 102, 103, 105. This can be, for example, a paging request, and the like.

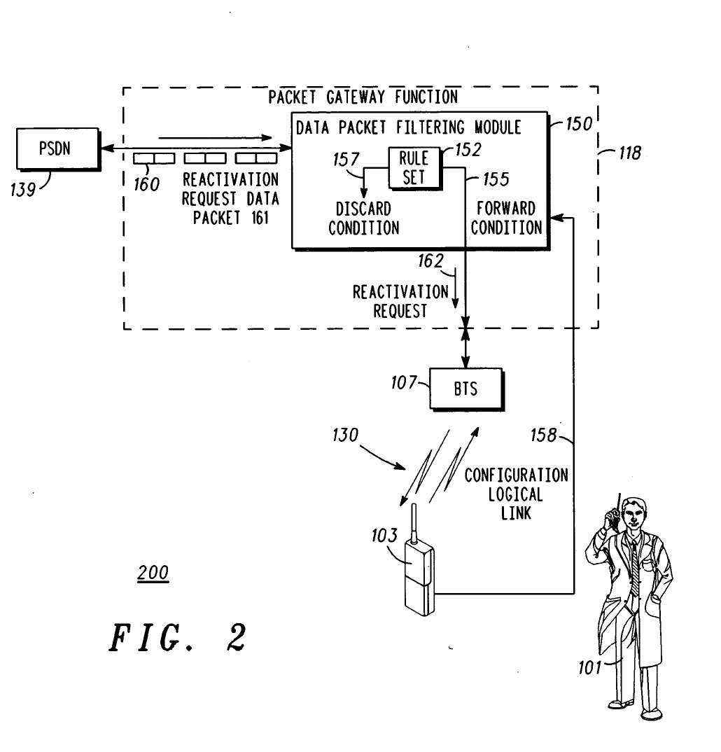

FIG. 2 representatively illustrates a more detailed block diagram of a wireless communication system 200 in accordance with an exemplary embodiment of the present invention. Only one BTS 107 and one mobile station 103 are shown for clarity. However, other BTS's and mobile stations may be included and be within the scope of the invention.

As shown in FIG. 2, the plurality of packets 160 arriving at the RAN may be processed by the packet gateway function 118. Plurality of packets 160 may include one or more reactivation request data packets 161 coupled to reactivate mobile station 103 that is in a dormant state. For example, reactivation request data packet 161 may be a data packet coupled to reactivate mobile station 103 in a push-to-talk session, reactivate mobile station 103 to begin a data transfer session, and the like.

In an embodiment, packet gateway function 118 may include data packet filtering module 150 coupled to filter reactivation request data packets 161 prior to reactivation of mobile station 103. Data packet filtering module 150 may include a rule set 152 that defines a set of conditions on whether a reactivation request data packet 161 is to be forwarded to and reactivate mobile station 103 or be discarded. In an embodiment, data packet filtering module 150 only filters reactivation request data packets 161 if mobile station 103 is a dormant state and a reactivation request 162 is not already pending for the mobile station 103. Other data packets that are not reactivation request data packets 161 or are reactivation request data packets bound for a mobile station 103 that already has a reactivation request 162 pending, may not filtered through data packet filtering module 150. This reduces the overhead associated with preventing unwanted reactivation requests in RAN 104 since only certain packets that are requesting reactivation of a mobile station in a dormant state are filtered through data packet filtering module 150.

In an embodiment, rule set 152 may be unique to mobile station 103. In other words, each mobile station coupled to RAN 104 may have its own unique rule set 152 that defines which reactivation request data packets 161 are allowed to reactivate mobile station 103. In another embodiment, rule set 152 may be defined and modified by a subscriber 101 of mobile station 103, for example though configuration logical link 158. In an embodiment, configuration logical link 158 may be a wired or wireless link used by a subscriber 101 or other entity to define or modify rule set 152. In an embodiment, rule set 152 may be defined or modified from mobile station 103 by subscriber 101 using configuration logical link 158 to packet gateway function 118. In another embodiment, rule set 152 may be defined and/or modified from a third party device such as a computer (using the Internet), other mobile station, and the like using configuration logical link 158.

In an embodiment, rule set 152 may define one or more conditions that allow or prevent a reactivation request data packet 161 from reactivating a mobile station 103 in a dormant state. For example and without limitation, rule set 152 may define one or more source IP addresses, servers, other mobile stations, networks, and the like, from which a reactivation request data packet 161 may or may not be allowed to reactivate mobile station. In another example, rule set 152 may define which protocols may or may not reactivate mobile station 103 for example Transmission Control Protocol (TCP) and User Datagram Protocol (UDP), and the like.

In an exemplary embodiment, rule set 152 may comprise a white list with one or more blocking exceptions. A white list allows all reactivation request data packets 161 to reactivate mobile station 103 exception for ones that meet the criteria of the blocking exceptions. For example, blocking exceptions may include a list of one or more source IP addresses, servers, other mobile stations, networks, and the like, from which a reactivation request data packet 161 may not be allowed to reactivate mobile station 103. In another example, blocking exceptions may include one or more protocols of a reactivation request data packet that may not be allowed to reactivate mobile station 103. For example, blocking exceptions may specify that only TCP reactivation request data packets are not allowed to reactivate mobile station 103.

In another exemplary embodiment, rule set 152 may comprise a black list with one or more passing exceptions. A black list prevents all reactivation request data packets 161 from reactivating mobile station 103 exception for ones that meet the criteria of the passing exceptions. For example, passing exceptions may include a list of one or more source IP addresses, servers, other mobile stations, networks, and the like, from which a reactivation request data packet 161 is allowed to reactivate mobile station 103. In another example, passing exceptions may include one or more protocols of a reactivation request data packet that are allowed to reactivate mobile station 103. For example, passing exceptions may specify that only TCP reactivation request data packets are allowed to reactivate mobile station 103.

In operation, if mobile station 103 is in a dormant state and a reactivation request 162 is not already pending for that mobile station, then data packet filtering module 150 may identify reactivation request data packet 161 from plurality of packets 160 and evaluate the reactivation request data packet 161 against a rule set 152 that is unique to mobile station 103 to determine whether to forward or discard the reactivation request data packet 161. If mobile station 103 is not in a dormant state (i.e. in an active communication session) or a reactivation request is already pending for mobile station 103, then data packet filtering module 150 does not evaluate (i.e. filter) any data packets for that mobile station, particularly reactivation request data packets 161.

If the mobile station 103 is in a dormant state and a reactivation request 162 is not pending, then data packet filtering module 150 evaluates reactivation request data packet 161 intended for mobile station 103 against rule set 152 for mobile station 103. Reactivation request data packet 161 may be forwarded if data packet filtering module 150 indicates a forward condition 155. Forwarding reactivation request data packet 161 allows the reactivation of mobile station 103 from a dormant state. This may include forwarding a reactivation request 162 and allocating channels and resources necessary for reactivation. Reactivation request data packet 161 may be discarded if data packet filtering module 150 indicates a discard condition 157. Discarding reactivation request data packet 161 prevents the reactivation of mobile station 103 from a dormant state. This includes preventing the allocation of channels and resources necessary for reactivation. Forward condition 155 and discard condition 157 are determined based on the rule set 152 unique to mobile device 103, where rule set 152 may include white or black lists with exceptions as discussed above.

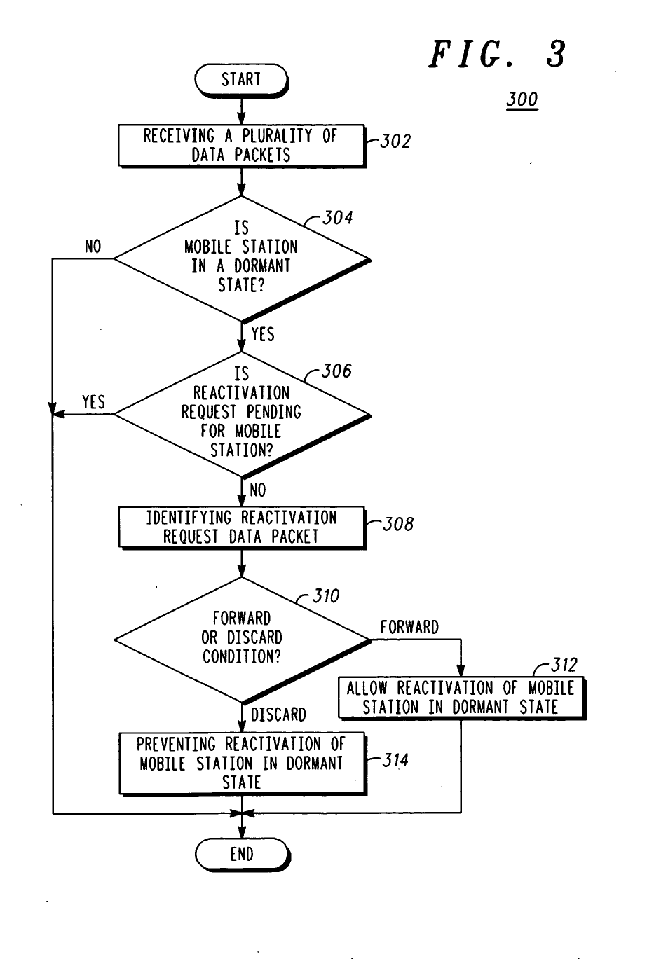

FIG. 3 representatively illustrates flow diagram in accordance with an exemplary embodiment of the present invention. In step 302, a radio access network receives a plurality of packets, where the plurality of packets include at least one reactivation request data packet coupled to request reactivation of a mobile station in a dormant state.

In step 304 it is determined if mobile station is in a dormant state (i.e. coupled to the RAN but not in an active data session). If so, in step 306 it is determined if a reactivation request is already pending for mobile station. If mobile station is not in a dormant state or a reactivation request is pending, then the process ends as shown. If mobile station is in a dormant state and a reactivation request is not pending, then in step 308 a data packet filtering module at a packet gateway function of the RAN identifies the reactivation request data packet from the plurality of packets.

In step 310 the data packet filtering module evaluates the reactivation request data packet against a rule set unique to the mobile station and determines if the reactivation request data packet is allowed to reactivate the mobile station or not. If data packet filtering module indicates a forward condition in step 310, then the reactivation request data packet is allowed to reactivate mobile station per step 312, and channels and other resources are allocated to allow reactivation. If data packet filtering module indicates a discard condition in step 310, then reactivation request data packet is discarded per step 314 and prevented from reactivating mobile station from a dormant state.

The above method has the advantage of greatly reducing the overhead associated with implementing a filter of reactivation request data packets since the unique rule set for each mobile station is only applied against a small number of incoming data packets. In essence, data packet filtering module at packet control function acts as a firewall for a limited number of packets that meet a series of conditions that are based on the state of the mobile station (dormant or active) and the unique rule set defined by a subscriber of the mobile station. This is contrasted with a traditional, prior art firewall that filters all incoming data packets regardless of the state of the mobile station, which introduces unacceptable overhead into processing of data packets. Further, filtering the incoming data packets at the packet gateway function has advantages over the prior art. A firewall or filtering scheme at the mobile station is ineffective because filtering occurs after resources have been allocated for the air interface, leaving the mobile station susceptible to denial of service attacks. A firewall or filtering scheme before the packet gateway function (i.e. at the PDSN) is inefficient because of the large number of subscribers and because the state of the mobile station (dormant or active) is not known requiring that all data packets be filtered.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method of filtering a plurality of data packets, comprising:
a radio access network (RAN) receiving the plurality of data packets;
if a mobile station coupled to the RAN is in a dormant state and a reactivation request is not pending for the mobile station:
a data packet filtering module located at a packet gateway function of the RAN identifying a reactivation request data packet from the plurality of data packets, wherein the reactivation request data packet is coupled to reactivate the mobile station;
the data packet filtering module evaluating the reactivation request data packet against a rule set, wherein the rule set is unique to the mobile station;
forwarding the reactivation request data packet if data packet filtering module indicates a forward condition; and
discarding the reactivation request data packet if data packet filtering module indicates a discard condition.

2. The method of claim 1, wherein the rule set is defined by a subscriber of the mobile station.

3. The method of claim 1, wherein the rule set is coupled to be modified by a subscriber of the mobile station.

4. The method of claim 1, wherein discarding the reactivation request data packet comprises preventing the reactivation request data packet from reactivating the mobile station.

5. The method of claim 1, wherein forwarding the reactivation request data packet comprises allowing the reactivation request data packet to reactivate the mobile station from the dormant state.

6. The method of claim 1, wherein the RAN is a CDMA network.

7. The method of claim 1, wherein the packet gateway function is a packet control function of a CDMA network.

8. The method of claim 1, wherein the rule set comprises a white list with one or more blocking exceptions.

9. The method of claim 1, wherein the rule set comprises a black list with one or more passing exceptions.

10. A radio access network (RAN) coupled to implement a method of filtering a plurality of data packets, comprising:
receiving the plurality of data packets;
if a mobile station coupled to the RAN is in a dormant state and a reactivation request is not pending for the mobile station:
a data packet filtering module located at a packet gateway function of the RAN identifying a reactivation request data packet from the plurality of data packets, wherein the reactivation request data packet is coupled to reactivate the mobile station;
the data packet filtering module evaluating the reactivation request data packet against a rule set, wherein the rule set is unique to the mobile station;
forwarding the reactivation request data packet if data packet filtering module indicates a forward condition; and
discarding the reactivation request data packet if data packet filtering module indicates a discard condition.

11. The radio access network of claim 10, wherein the rule set is defined by a subscriber of the mobile station.

12. The radio access network of claim 10, wherein the rule set is coupled to be modified by a subscriber of the mobile station.

13. The radio access network of claim 10, wherein discarding the reactivation request data packet comprises preventing the reactivation request data packet from reactivating the mobile station.

14. The radio access network of claim 10, wherein forwarding the reactivation request data packet comprises allowing the reactivation request data packet to reactivate the mobile station from the dormant state.

15. The radio access network of claim 10, wherein the RAN is a CDMA network.

16. The radio access network of claim 10, wherein the packet gateway function is a packet control function of a CDMA network.

17. The radio access network of claim 10, wherein the rule set comprises a white list with one or more blocking exceptions.

18. The radio access network of claim 10, wherein the rule set comprises a black list with one or more passing exceptions.

19. A packet gateway function coupled to implement a method of filtering a plurality of data packets, comprising:
receiving the plurality of data packets;
if a mobile station coupled to the packet gateway function is in a dormant state and a reactivation request is not pending for the mobile station:
a data packet filtering module located at the packet gateway function identifying a reactivation request data packet from the plurality of data packets, wherein the reactivation request data packet is coupled to reactivate the mobile station;
the data packet filtering module evaluating the reactivation request data packet against a rule set, wherein the rule set is unique to the mobile station;
forwarding the reactivation request data packet if data packet filtering module indicates a forward condition; and
discarding the reactivation request data packet if data packet filtering module indicates a discard condition.

20. The packet gateway function of claim 19, wherein the rule set is coupled to be modified by a subscriber of the mobile station.

21. The packet gateway function of claim 19, wherein discarding the reactivation request data packet comprises preventing the reactivation request data packet from reactivating the mobile station.

22. The packet gateway function of claim 19, wherein forwarding the reactivation request data packet comprises allowing the reactivation request data packet to reactivate the mobile station from the dormant state.

23. The packet gateway function of claim 19, wherein the rule set comprises a white list with one or more blocking exceptions.

24. The packet gateway function of claim 19, wherein the rule set comprises a black list with one or more passing exceptions.
